(19) United States
(12) Patent Application Publication
(10) Pub. No.: US 2026/0264670 A1
(43) Pub. Date: Sep. 10, 2026

(54) TRAILER HITCH CONNECTION FAILURE CONTROL IN ABRUPT DYNAMIC DISTURBANCE

(71) Applicant: GM Global Technology Operations LLC, Detroit, MI (US)

(72) Inventors: Mohammadali Shahriari, Markham (CA); Mehdi Abroshan, Whitby (CA); Zhi Li, Unionville (CA); Ben MacCallum, Toronto (CA); Benjamin J. Eles, Goodrich, MI (US)

(21) Appl. No.: 19/073,452

(22) Filed: Mar. 7, 2025

(51) Int. Cl. B60W 30/09; B60D 1/24; B60D 1/28; B60W 30/16; B60W 40/13; G07C 5/02

(52) U.S. Cl. CPC B60W 30/09; B60D 1/249; B60D 1/28; B60W 30/16; B60W 30/181; B60W 2300/14; B60W 2510/207; B60W 2520/10; B60W 2530/10; B60W 2540/12

(57) ABSTRACT

A system for trailer hitch connection failure control in abrupt dynamic disturbances includes a towing vehicle connected to a trailer via a hitch and one or more restraining devices. Sensors integrated into the towing vehicle detect static and dynamic state information about the vehicle, and actuators integrated into the towing vehicle alter the vehicle static and dynamic state. A hitch failure control (HFC) application monitors vehicle static and dynamic state information, determines that a flexible connection exists between the towing vehicle and the trailer, performs flexible connection control, including: receiving commands from a towing vehicle operator; and actively, automatically, and dynamically modifies the commands from the towing vehicle operator to maintain relative positions of the towing vehicle and the trailer within a gap distance xr that effectively prevents collisions between the towing vehicle and the trailer

### INTRODUCTION

The present disclosure relates to trailer towing technologies, and more specifically to active safety systems supporting vehicles towing trailers. Typical active safety and/or advanced driver assistance system (ADAS) functionality, when applied to trailering, offer assistance in lane keeping, lane centering, and adaptive cruise control.

While current systems and methods of ADAS-aided or other such active safety system-aided trailer control achieve their intended purpose, there is a need for new and improved systems and methods for managing vehicle and trailer performance that reduce the potential for the trailer to collide with the towing vehicle during a hitch connection failure, or under other circumstances where the vehicle/trailer connection is flexible, where such new systems and methods utilize existing hardware, and maintain or reduce system complexity, maintain or reduce manufacturing complexity, may be retrofitted to existing vehicles that are equipped with appropriate hardware, may be remotely updatable, and that offer improved functionality and redundancy.

### SUMMARY

According to several aspects of the present disclosure a system for trailer hitch connection failure control in abrupt dynamic disturbances includes a towing vehicle connected to a trailer via a hitch and one or more restraining devices. The system further includes one or more sensors integrated into the towing vehicle, the one or more sensors detecting static and dynamic state information about the towing vehicle. The system further includes one or more actuators integrated into the towing vehicle, the one or more actuators altering the static and dynamic state of the towing vehicle. The system further includes a controller having a processor, a memory, and input/output (I/O) ports. The I/O ports are in communication with the one or more sensors and the one or more actuators. The processor executes program code portions stored in the memory. The program code portions include a hitch failure control (HFC) application having at least first, second, third, fourth, and fifth control logics. The first control logic monitors vehicle static and dynamic state information. The second control logic determines that a flexible connection exists between the towing vehicle and the trailer. The third control logic performs flexible connection control, including: the fourth control logic that receives commands from a towing vehicle operator; the fifth control logic that actively, automatically, and dynamically modifies the commands from the towing vehicle operator to maintain relative positions of the towing vehicle and the trailer within a gap distance xr that effectively prevents collisions between the towing vehicle and the trailer.

In another aspect of the present disclosure the one or more sensors further include: one or more electromagnetic (EM) sensors capturing electromagnetic information about the towing vehicle and the trailer, where the electromagnetic information includes optical information capturing the hitch. The one or more sensors further include one or more inertial measurement units (IMUs) capturing acceleration, velocity, and position information about the towing vehicle and the trailer. The one or more sensors further include one or more powertrain system sensors, including: transmission sensors, and engine control sensors, the powertrain system sensors detecting a state of the powertrain system of the towing vehicle; and one or more brake sensors, the brake sensors detecting a quantity of torque currently being supplied to one or more axles of the towing vehicle.

In yet another aspect of the present disclosure the second control logic further includes control logic for estimating an accelerating mass and a braking mass according to:

$${\hat{m}}_{a} = \frac{{F}_{a x l}}{{a}_{x}} ; and \qquad Eq . 1$$

$${\hat{m}}_{b} = \frac{{F}_{a x l}}{{a}_{x}} , \qquad Eq . 2$$

where \hat{m}ₐ is an accelerating mass of the towing vehicle, and \hat{m}_{b} is a decelerating mass of the towing vehicle, aₓ is a longitudinal acceleration measured by the one or more IMUs, and Fₐₓₗ is a measured force acting on one or more axles of the towing vehicle.

In yet another aspect of the present disclosure the second control logic further includes control logic for generating a mass difference estimation according to:

$$Δ \hat{m} = \vert {\hat{m}}_{a} - {\hat{m}}_{b} \vert , \qquad Eq . 3$$

where:

$$Δ \hat{m} > Δ {m}^{tr} . \qquad Eq . 4$$

such that when a change in mass estimation (Δ\hat{m}) is greater than a mass difference threshold Δm^{tr}, then a flexible connection between the trailer the towing vehicle exists.

In yet another aspect of the present disclosure the second control logic further includes control logic for performing lateral flexible connection detection based on an understeer coefficient of the towing vehicle Δkᵤₛ and an understeer coefficient threshold

$$Δ {k}_{us}^{tr} ,$$

where:

$$Δ {k}_{u s} = \vert Δ {k}_{u s} ( k ) - Δ {k}_{u s} ( k - 1 ) \vert , \qquad Eq . 10$$

such that a change in understeer coefficient Δkᵤₛ of the towing vehicle that exceeds the understeer coefficient threshold

$$Δ {k}_{us}^{tr} ,$$

represented as:

$$Δ {k}_{u s} > Δ {k}_{u s}^{tr} , \qquad Eq . 11$$

indicates that a flexible connection between the towing vehicle and the trailer exists.

In yet another aspect of the present disclosure the second control logic further includes control logic for measuring and generating, via the EM sensors, an estimated distance between the towing vehicle and the trailer, and upon determining that the estimated distance exceeds a predetermined hitched distance at rest changes while the towing vehicle and trailer are in motion, a longitudinally flexible connection is detected. The second control logic further performs ball joint detection with information from the one or more EM sensors, and upon detecting a ball joint, determines that a flexible connection is present.

In yet another aspect of the present disclosure the third control logic further includes control logic for utilizing a driver brake pressure model to generate a trailer braking gain and a towing vehicle velocity, and control logic for monitoring, via a towing vehicle axle torque controller, a current gap distance and comparing the current gap distance to a desired gap distance, and generating a towing vehicle axle torque command. The third control logic further includes control logic for monitoring, via a trailer brake controller, the current gap distance and comparing the current gap distance to the desired gap distance, and generating a trailer brake command, and control logic for combining the towing vehicle velocity and the towing vehicle axle torque command, and control logic for combining the trailer brake command and the trailer braking gain.

In yet another aspect of the present disclosure the third control logic further includes control logic for calculating a spring constant that emulates a rope-type hitch with a maximum length of xr_max and a minimum length of zero. The minimum length of zero indicates the towing vehicle and the trailer are in contact with one another, and the maximum length xr_max defines a condition in which the flexible connection, defined by the one or more restraining devices, is expanded to a largest possible distance.

In yet another aspect of the present disclosure the fourth control logic further includes control logic for calculating a supervised gap distance and a corrected velocity of the towing vehicle (v1) that mitigates, reduces, or substantially eliminates bouncing or pogoing of a towing vehicle-trailer physical system.

In yet another aspect of the present disclosure the fifth control logic further includes control logic that executes a flexible connection control algorithm that actively, automatically, and continuously adjusts towing vehicle operator command inputs to alter or correct the towing vehicle velocity v1 according to:

$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$

where: ΔFᵣ is a required corrective longitudinal force, kₚ is a control turning parameter, β₁ is a damping of the vehicle model, e is an error between desired and actual distances between the trailer and the towing vehicle, m₁ is a towing vehicle mass, m₂ is a trailer mass, Δxᵣ is a trailer to towing vehicle connection deflection, β₂ is a damping of the trailer model, k is a stiffness of the connection between the trailer and the towing vehicle, Fᵣ is a total axle force, v₁ is a longitudinal velocity of the towing vehicle, v₂ is a longitudinal velocity of the trailer, x_{r,d} is a length of the restraining device defining the gap distance xr. Outputs of the flexible connection control algorithm are used as inputs to one or more advanced driver assistance system (ADAS) functions of the towing vehicle that dynamically, automatically, and continuously alter a longitudinal acceleration or deceleration of the towing vehicle to mitigate, reduce, or substantially eliminate collisions between the towing vehicle and the trailer while a flexible connection between the towing vehicle and the trailer is present.

In yet another aspect of the present disclosure a method for trailer hitch connection failure control in abrupt dynamic disturbances includes: detecting, via one or more sensors integrated into a towing vehicle, static and dynamic state information about the towing vehicle, the towing vehicle connected to a trailer via a hitch and one or more restraining devices. The method further includes altering, via one or more actuators integrated into the towing vehicle, the static and dynamic state of the towing vehicle. The method further includes executing, with a processor of a controller, program code portion stored in memory of the controller. The controller also has one or more input/output (I/O) ports in communication with the one or more sensors and the one or more actuators. The program code portions include a hitch failure control (HFC) application having control logic for monitoring vehicle static and dynamic state information, and for determining that a flexible connection exists between the towing vehicle and the trailer. The HFC application further includes control logic for performing flexible connection control, including: receiving commands from a towing vehicle operator; and actively, automatically, and dynamically modifying the commands from the towing vehicle operator to maintain relative positions of the towing vehicle and the trailer within a gap distance xr that effectively prevents collisions between the towing vehicle and the trailer.

In yet another aspect of the present disclosure the method further includes capturing, via one or more electromagnetic (EM) sensors, electromagnetic information about the towing vehicle and the trailer. The electromagnetic information includes optical information relating to the hitch. The method further includes capturing, via one or more inertial measurement units (IMUs), acceleration, velocity, and position information about the towing vehicle and the trailer. The method further includes detecting, via one or more powertrain system sensors, a state of a powertrain system of the towing vehicle, the powertrain system sensors comprising: transmission sensors, and engine control sensors, and detecting, via one or more brake sensors, a quantity of torque currently being supplied to one or more axles of the towing vehicle.

In yet another aspect of the present disclosure, the method further includes estimating an accelerating mass and a braking mass according to:

$${\hat{m}}_{a} = \frac{{F}_{a x l}}{{a}_{x}} ; and \qquad Eq . 1$$

$${\hat{m}}_{b} = \frac{{F}_{a x l}}{{a}_{x}} , \qquad Eq . 2$$

where \hat{m}ₐ is an accelerating mass of the towing vehicle, and \hat{m}_{b} is a decelerating mass of the towing vehicle, aₓ is a longitudinal acceleration measured by the one or more IMUs, and Fₐₓₗ is a measured force acting on one or more axles of the towing vehicle.

In yet another aspect of the present disclosure, the method further includes: generating a mass difference estimation according to:

$$Δ \hat{m} = \vert {\hat{m}}_{a} - {\hat{m}}_{b} \vert , \qquad Eq . 3$$

where:

$$Δ \hat{m} > Δ {m}^{tr} . \qquad Eq . 4$$

such that when a change in mass estimation (Δ\hat{m}) is greater than a mass difference threshold Δm^{tr}, then a flexible connection between the trailer the towing vehicle exists.

In yet another aspect of the present disclosure, the method further includes: performing lateral flexible connection detection based on an understeer coefficient of the towing vehicle Δkᵤₛ and an understeer coefficient threshold

$$Δ {k}_{us}^{tr} ,$$

where:

$$Δ {k}_{u s} = \vert Δ {k}_{u s} ( k ) - Δ {k}_{u s} ( k - 1 ) \vert , \qquad Eq . 10$$

such that a change in understeer coefficient Δkᵤₛ of the towing vehicle that exceeds the understeer coefficient threshold

$$Δ {k}_{us}^{tr} ,$$

represented as:

$$Δ {k}_{u s} > Δ {k}_{u s}^{tr} , \qquad Eq . 11$$

indicates that a flexible connection between the towing vehicle and the trailer exists.

In yet another aspect of the present disclosure, the method further includes: measuring and generating, via the EM sensors, an estimated distance between the towing vehicle and the trailer, and upon determining that the estimated distance exceeds a predetermined hitched distance at rest changes while the towing vehicle and trailer are in motion, a longitudinally flexible connection is detected; and performing ball joint detection with information from the one or more EM sensors, and upon detecting a ball joint, determining that a flexible connection is present.

In yet another aspect of the present disclosure, the method further includes: generating, with a driver brake pressure model, a trailer braking gain and a towing vehicle velocity; and monitoring, via a towing vehicle axle torque controller, a current gap distance and comparing the current gap distance to a desired gap distance, and generating a towing vehicle axle torque command. The method further includes monitoring, via a trailer brake controller, the current gap distance and comparing the current gap distance to the desired gap distance, and generating a trailer brake command; and combining the towing vehicle velocity and the towing vehicle axle torque command, and control logic for combining the trailer brake command and the trailer braking gain.

In yet another aspect of the present disclosure, the method further includes: calculating a spring constant that emulates a rope-type hitch with a maximum length of xr_max and a minimum length of zero. The minimum length of zero indicates the towing vehicle and the trailer are in contact with one another. The maximum length xr_max defines a condition in which the flexible connection, defined by the one or more restraining devices, is expanded to a largest possible distance. The method further includes calculating a supervised gap distance and a corrected velocity of the towing vehicle (v1) that mitigates, reduces, or substantially eliminates bouncing or pogoing of a towing vehicle-trailer physical system.

In yet another aspect of the present disclosure, the method further includes: executing a flexible connection control algorithm that actively, automatically, and continuously adjusts towing vehicle operator command inputs to alter or correct the towing vehicle velocity v1 according to:

$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$

where: ΔFᵣ is a required corrective longitudinal force, kₚ is a control turning parameter, β₁ is a damping of the vehicle model, e is an error between desired and actual distances between the trailer and the towing vehicle, m₁ is a towing vehicle mass, m₂ is a trailer mass, Δxᵣ is a trailer to towing vehicle connection deflection, β₂ is a damping of the trailer model, k is a stiffness of the connection between the trailer and the towing vehicle, Fᵣ is a total axle force, v₁ is a longitudinal velocity of the towing vehicle, v₂ is a longitudinal velocity of the trailer, x_{r,d} is a length of the restraining device defining the gap distance xᵣ. Outputs of the flexible connection control algorithm are used as inputs to one or more advanced driver assistance system (ADAS) functions of the towing vehicle that dynamically, automatically, and continuously alter a longitudinal acceleration or deceleration of the towing vehicle to mitigate, reduce, or substantially eliminate collisions between the towing vehicle and the trailer while a flexible connection between the towing vehicle and the trailer is present.

In yet another aspect of the present disclosure a method for trailer hitch connection failure control in abrupt dynamic disturbances includes: detecting, via one or more sensors integrated into a towing vehicle, static and dynamic state information about the towing vehicle, the towing vehicle connected to a trailer via a hitch and one or more restraining devices, and altering, via one or more actuators integrated into the towing vehicle, the static and dynamic state of the towing vehicle. The method further includes executing, with a processor of a controller, program code portion stored in memory of the controller. The controller further includes one or more input/output (I/O) ports in communication with the one or more sensors and the one or more actuators. The program code portions include a hitch failure control (HFC) application having control logic for: monitoring vehicle static and dynamic state information, including: capturing, via one or more electromagnetic (EM) sensors, electromagnetic information about the towing vehicle and the trailer. The electromagnetic information includes optical information relating to the hitch. The HFC application further includes control logic for capturing, via one or more inertial measurement units (IMUs), acceleration, velocity, and position information about the towing vehicle and the trailer. The HFC application further includes control logic for detecting, via one or more powertrain system sensors, a state of a powertrain system of the towing vehicle, the powertrain system sensors including: transmission sensors, and engine control sensors. The HFC application further includes control logic for detecting, via one or more brake sensors, a quantity of torque currently being supplied to one or more axles of the towing vehicle. The HFC application further includes control logic for determining that a flexible connection exists between the towing vehicle and the trailer, including: estimating an accelerating mass and a braking mass according to:

$${\hat{m}}_{a} = \frac{{F}_{a x l}}{{a}_{x}} ; and \qquad Eq . 1$$

$${\hat{m}}_{b} = \frac{{F}_{a x l}}{{a}_{x}} , \qquad Eq . 2$$

where \hat{m}ₐ is an accelerating mass of the towing vehicle, and my is a decelerating mass of the towing vehicle, aₓ is a longitudinal acceleration measured by the one or more IMUs, and Fₐₓₗ is a measured force acting on one or more axles of the towing vehicle. The HFC application further includes control logic for generating a mass difference estimation according to:

$$Δ \hat{m} = \vert {\hat{m}}_{a} - {\hat{m}}_{b} \vert , \qquad Eq . 3$$

where:

$$Δ \hat{m} > Δ {m}^{tr} . \qquad Eq . 4$$

such that when a change in mass estimation (Δ\hat{m}) is greater than a mass difference threshold Δm^{tr}, then a flexible connection between the trailer the towing vehicle exists. The HFC application further includes control logic for performing lateral flexible connection detection based on an understeer coefficient of the towing vehicle Δkᵤₛ and an understeer coefficient threshold

$$Δ {k}_{us}^{tr} ,$$

where:

$$Δ {k}_{u s} = \vert {Δk}_{u s} ( k ) - Δ {k}_{u s} ( k - 1 ) \vert , \qquad Eq . 10$$

such that a change in understeer coefficient Δkᵤₛ of the towing vehicle that exceeds the understeer coefficient threshold

$$Δ {k}_{us}^{tr} ,$$

represented as:

$$Δ {k}_{u s} > Δ {k}_{u s}^{tr} , \qquad Eq . 11$$

indicates that a flexible connection between the towing vehicle and the trailer exists. The HFC application further includes control logic for measuring and generating, via the EM sensors, an estimated distance between the towing vehicle and the trailer, and upon determining that the estimated distance exceeds a predetermined hitched distance at rest changes while the towing vehicle and trailer are in motion, a longitudinally flexible connection is detected. The HFC application further includes control logic for performing ball joint detection with information from the one or more EM sensors, and upon detecting a ball joint, determining that a flexible connection is present. The HFC application further includes control logic for performing flexible connection control, including: receiving commands from a towing vehicle operator, and generating, with a driver brake pressure model, a trailer braking gain and a towing vehicle velocity. The HFC application further includes control logic for monitoring, via a towing vehicle axle torque controller, a current gap distance and comparing the current gap distance to a desired gap distance, and generating a towing vehicle axle torque command, and for monitoring, via a trailer brake controller, the current gap distance and comparing the current gap distance to the desired gap distance, and generating a trailer brake command. The HFC application further includes control logic for combining the towing vehicle velocity and the towing vehicle axle torque command, and control logic for combining the trailer brake command and the trailer braking gain. The HFC application further includes control logic for calculating a spring constant that emulates a rope-type hitch with a maximum length of xr_max and a minimum length of zero. The minimum length of zero indicates the towing vehicle and the trailer are in contact with one another. The maximum length xr_max defines a condition in which the flexible connection, defined by the one or more restraining devices, is expanded to a largest possible distance. The HFC application further includes control logic for calculating a supervised gap distance and a corrected velocity of the towing vehicle (v1) that mitigates, reduces, or substantially eliminates bouncing or pogoing of a towing vehicle-trailer physical system. The HFC application further includes control logic for executing a flexible connection control algorithm that actively, automatically, and continuously adjusts towing vehicle operator command inputs to alter or correct the towing vehicle velocity v1 according to:

$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$

where: ΔFᵣ is a required corrective longitudinal force, kₚ is a control turning parameter, β₁ is a damping of the vehicle model, e is an error between desired and actual distances between the trailer and the towing vehicle, m₁ is a towing vehicle mass, m₂ is a trailer mass, Δxᵣ is a trailer to towing vehicle connection deflection, β₂ is a damping of the trailer model, k is a stiffness of the connection between the trailer and the towing vehicle, Fᵣ is a total axle force, v₁ is a longitudinal velocity of the towing vehicle, v₂ is a longitudinal velocity of the trailer, x_{r,d} is a length of the restraining device that defines the gap distance xᵣ. Outputs of the flexible connection control algorithm are used as inputs to one or more advanced driver assistance system (ADAS) functions of the towing vehicle that actively, dynamically, automatically, and continuously alter or modify the commands from the towing vehicle operator to adjust a longitudinal acceleration or deceleration of the towing vehicle and to maintain relative positions of the towing vehicle and the trailer within the gap distance xᵣ that effectively prevents collisions between the towing vehicle and the trailer while a flexible connection between the towing vehicle and the trailer is present.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for trailer hitch connection failure control in abrupt dynamic disturbances according to an exemplary embodiment;

FIG. 2A is a simplified a schematic diagram of the system for trailer hitch connection failure control in abrupt dynamic disturbances of FIG. 1, where the the trailer is disconnected from the vehicle at the hitch, but safety chains retain the trailer in flexible connection with the vehicle according to an exemplary embodiment;

FIG. 2B is a simplified a schematic diagram of the system for trailer hitch connection failure control in abrupt dynamic disturbances of FIG. 1, where the the towing vehicle is attached to a towed vehicle via a rope in a flexible connection according to an exemplary embodiment;

FIG. 3 is a flowchart depicting logical flow of a hitch failure control (HFC) application of the system for trailer hitch connection failure control in abrupt dynamic disturbances of FIG. 1 according to an exemplary embodiment;

FIG. 4 is a flowchart depicting a simplified towing detection subroutine of the HFC application of FIG. 3 according to an exemplary embodiment;

FIG. 5 is a simplified flowchart depicting vehicle-trailer plant dynamic control modifications within the HFC application of FIG. 3 according to an exemplary embodiment; and

FIG. 6 is a flowchart depicting logical flow of a gap distance xᵣ management portion of the HFC application of FIG. 3 according to an exemplary embodiment.

### DETAILED DESCRIPTION

The following description is merely exemplary in nature and is not intended to limit the present disclosure, application, or uses.

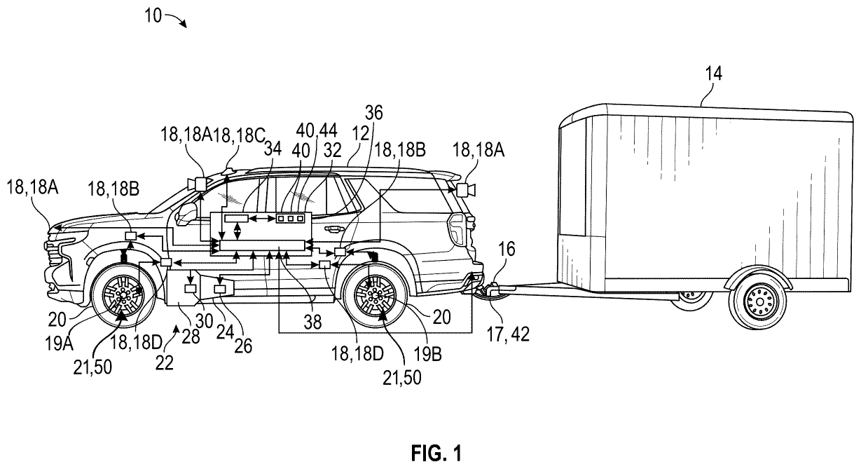

Referring to FIG. 1, a system 10 for trailer hitch connection failure control in abrupt dynamic disturbances is shown schematically. The system 10 includes a towing vehicle 12 connected to a trailer 14 via a hitch 16. The towing vehicle 12 is illustrated as a passenger vehicle, however, it should be appreciated that the towing vehicle 12 may be any type of vehicle, including but not limited to: cars, trucks, sport utility vehicles (SUVs), vans, motor homes, semis, tractor-trailers, delivery vehicles including vehicles used within warehouses, tricycles, motorcycles, planes, amphibious vehicles, or any other such towing vehicle 12 which both makes contact with the ground and which may be connected to a trailer 14. Similarly, the trailer 14 is depicted as a vehicle hauling trailer or flatbed trailer, however it should be appreciated that the trailer 14 may be any type of trailer 14, including but not limited to: enclosed trailers, dump trailers, flatbed trailers, utility trailers, Conestoga trailers, car trailers, multi-vehicle trailers, lowboy trailers, refrigerated trailers, boat trailers, landscape trailers, car hauling trailers, gooseneck trailers, and the like. The hitch 16 is depicted as a receiver hitch with a ball attachment, however it will be appreciated that the hitch 16 may be any of a wide variety of hitches 16 such as receiver hitches, 5^{th} wheel hitches, gooseneck hitches, weight distribution hitches, pintle hitches, or the like. The towing vehicle 12 to trailer 14 connection is further augmented by one or more restraining or safety devices 17 which may include chains, ropes, or the like, without limitation or reservation.

The system 10 further includes one or more sensors 18 integrated into the towing vehicle 12 and/or the trailer 14. The sensors 18 detect static and dynamic information about the towing vehicle 12 and trailer 14, and may include, but are not limited to: electromagnetic (EM) sensors 18A such as cameras, infra-red cameras, video cameras, light detection and ranging (LiDAR) sensors, radio detection and ranging (RADAR) sensors, sound navigation and ranging (SONAR) sensors, and the like. EM sensors 18A, such as those described above, may be used to determine a proximity of the towing vehicle 12 and/or trailer 14 to one another, and/or to objects in the environment surrounding the towing vehicle 12 and/or trailer 14. The sensors 18 may further include sensors 18 capable of directly and/or indirectly measuring towing vehicle 12 and trailer 14 static and dynamic states, including but not limited to: inertial measurement units (IMUs), suspension sensors 18B and control units such as Semi Active Damping Suspension (SADS), air suspension sensors, continuous damping control (CDC) ride height sensors, global positioning system (GPS) sensors 18C, wheel 20 speed and/or brake 21 sensors 18D capable of measuring rotational speeds and/or torque being currently supplied to one or more of the wheels 20 or axles 19A, 19B of the towing vehicle 12, throttle position sensors, accelerator pedal position sensors, steering position sensors capable of measuring a steering system position, steering rate, and steering velocity, tire pressure monitoring systems, aerodynamic element position sensors, and the like. In several examples, the suspension sensors 18B and control units such as Semi Active Damping Suspension (SADS), air suspension sensors, continuous damping control (CDC) ride height sensors, and the like define towing vehicle 12 axle load detecting equipment, capable of monitoring a vertical or normal force loading of the suspension of the towing vehicle 12. More specifically, the suspension sensors 18B and control units such as Semi Active Damping Suspension (SADS), air suspension sensors, CDC ride height sensors, and the like of exemplary non-limiting embodiments are capable of directly and/or indirectly measuring a vertical or normal force loading and/or a vertical displacement or ride height of a front axle 19A and a rear axle 19B of the towing vehicle 12.

The IMUs can measure movement, acceleration, and the like in several degrees of freedom. In a specific example, the IMUs may measure position, movement, acceleration, etc. in at least three degrees of freedom. Likewise, the SADS sensors may be IMUs capable of measuring in three or more degrees of freedom. In some examples, the SADS may be suspension hub accelerometers, or the like. Accordingly, towing vehicle 12 state information may include any of a wide variety of data including but not limited to: wheel 20 speed data, SADS, GPS, and IMU data including attitude, acceleration, location, and the like. The sensors 18 may further include towing vehicle 12 powertrain system 22 sensors, including but not limited to transmission 24 sensors 26, engine 28 control sensors 30, and the like without departing from the scope or intent of the present disclosure. Powertrain system 22 sensors detect a state of the powertrain system 22, including a quantity of torque being currently produced by the engine 28, motor, or other prime mover of the towing vehicle 12. Similarly, transmission 24 sensors 26 detect a state of the transmission 24 of the towing vehicle 12, including a state of a torque multiplier, such as a gear ratio currently engaged within the transmission 24 of the towing vehicle 12.

The system 10 further includes one or more controllers 32 in communication with the various sensors 18 of the towing vehicle 12 and/or trailer 14, processes information received therefrom, and generates output signals that are used to control or alter performance of the towing vehicle 12 and/or trailer 14. The controllers 32 are integrated into the towing vehicle 12. More specifically, the controllers 32 are non-generalized, electronic control devices having a preprogrammed digital computer or processor 34, non-transitory computer readable medium or memory 36 used to store data such as control logic, software applications, instructions, computer code, data lookup tables, etc., and input/output (I/O) ports 38. Computer readable medium or memory 36 includes any type of medium capable of being accessed by a computer, such as read only memory (ROM), random access memory (RAM), a hard disk drive, a compact disk (CD), a digital video disc (DVD), or any other type of memory. A “non-transitory” computer readable memory 36 excludes wired, wireless, optical, or other communication links that transport transitory electrical or other signals. A non-transitory computer readable memory 36 includes media where data can be permanently stored, and media where data can be stored and later overwritten, such as a rewritable optical disc or an erasable memory device. Computer code includes any type of program code, including source code, object code, and executable code. The processor 34 is configured to execute the code or instructions. The towing vehicle 12 may have additional controllers 32 such as a dedicated Wi-Fi controller, an engine control module, a transmission control module, a body control module, an infotainment control module, or the like. The I/O ports 38 may be configured to communicate via wired communications, wirelessly via Wi-Fi protocols under IEEE 802.11x, or the like without departing from the scope or intent of the present disclosure.

The controller 32 further includes one or more applications 40. An application 40 is a software program configured to perform a specific function or set of functions. The application 40 may include one or more computer programs, software components, sets of instructions, procedures, functions, objects, classes, instances, related data, or portions thereof adapted for implementation in a suitable computer readable program code. The applications 40 may be stored within the memory 36 or in additional or separate memory 36. Examples of applications 40 include audio or video streaming services, games, browsers, social media, etc. In other examples, the applications 40 are used to manage body control system functions, suspension control system functions, transmission and/or engine control system functions or the like in an exemplary towing vehicle 12.

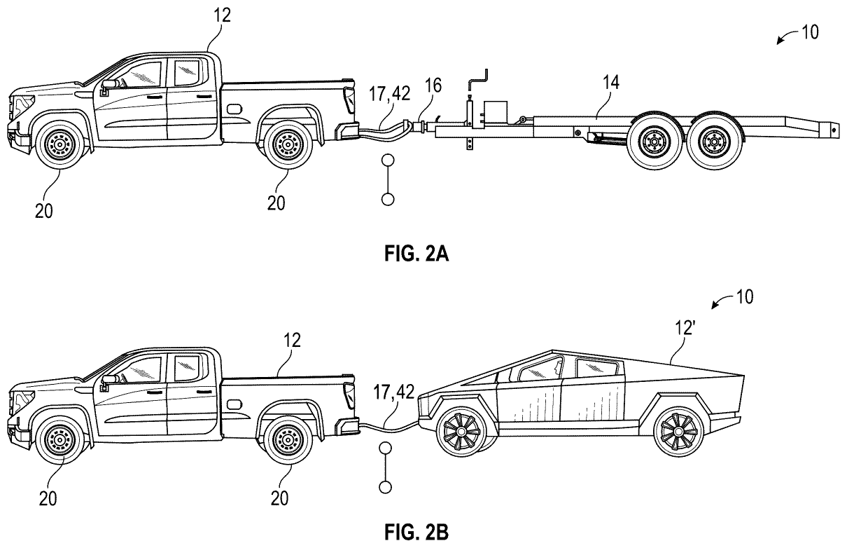

Referring now to FIGS. 2A and 2B, simplified schematic depictions of two non-limiting examples of the system 10 of FIG. 1 are shown. Specifically, FIG. 2A depicts the towing vehicle 12 connected to a flatbed hauling trailer 14, where the hitch 16 itself has become disconnected, but restraining or safety devices 17, specifically safety chains 42 remain properly attached to and connecting the towing vehicle 12 to the trailer 14. Likewise, FIG. 2B depicts the towing vehicle 12 connected to a towed vehicle 12′ via a flexible connection such as a safety chain 42, a rope, or the like. Since the system 10 of the present disclosure operates effectively in relation to both trailers 14 and towed vehicles 12′, hereinafter trailers 14 and towed vehicles 12′ may be referred to as such. However, the term “trailer” is also intended to encompass any towed device, including towed vehicles 12′ and trailers 14, such as those described hereinabove. In both FIGS. 2A and 2B, it will be appreciated that because the safety chains 42 and/or ropes are longitudinally flexible, the trailer 14 may move towards and/or away from the towing vehicle 12 in a longitudinal direction, because the connection between the towing vehicle 12 and the trailer 14 is not longitudinally inflexible, as would be the case if the hitch 16 was properly connected. Accordingly, in the situations depicted in FIGS. 2A and 2B, there is a potential that the trailer 14 or towed vehicle 12′, when connected to the towing vehicle 12 by a flexible connection, may approach and/or collide with the towing vehicle 12 under certain circumstances (i.e. braking, deceleration, or the like). That is, rates of longitudinal acceleration of the trailer 14 may depart from the rates of longitudinal acceleration of the towing vehicle 12, thereby allowing a distance between the towing vehicle 12 and the trailer 14 to change, or even become zero, resulting in a trailer 14-to-towing vehicle 12 collision.

It will be appreciated that it is undesirable for a trailer 14 to collide with the towing vehicle 12 for a variety of reasons, including but not limited to: vehicle 12 and/or trailer 14 occupant comfort and safety, the potential to cause physical damage to the vehicle 12, trailer 14 and/or towed vehicle 12′, and the like. Accordingly, the system 10 monitors a variety of parameters, including a status of a connection between the towing vehicle 12, trailer or towed vehicle 14, 12′, and systematically manages towing vehicle 12 dynamics to control towing vehicle 12 braking while assuring the flexible connection and distance between the towing vehicle 12 and towed vehicle 12′ and/or trailer 14 is maintained. In some situations, a trailering side connection may fail, be set up improperly and come loose, incorrect trailer 14 balls may be used (i.e. 1⅞″ instead of 2 5/16″, 2 5/16 rather than 3″, or vice versa) or mixed with the wrong coupling mechanism of the hitch 16. Additional flexible or failed connections may also occur when hitch 16 pins are not properly inserted or may be missing, cotter pins may not be used to secure the hitch 16 pins, and/or a trailer 14 coupling mechanism may become disconnected due to wear damage, or the like. When such flexible or failed connections occur, the system 10 utilizes restraining or safety devices 17 which may include chains, ropes, or the like to maintain a towing connection between the trailer 14 and the towing vehicle 12. In additional examples, where a fifth wheel or gooseneck trailer 14 is being towed by the towing vehicle 12, the gooseneck or fifth wheel hitch 16 may be disconnected due to hitch 16 failures, improper latching, absent or missing hitch pins, incorrect balls or ball sizes, and trailer 14 reactions to dynamic situations. In fifth wheel or gooseneck hitch 16 failures, the gooseneck portion of the trailer 14 will land in a bed of the towing vehicle 12, damaging the bed floor, bed side rails, and potentially resulting in towing vehicle 12 instability if the towing vehicle 12 and trailer 14 are in motion. In Fifth wheel trailers, the restraining or safety devices 17 utilize a breakaway cable that connects to and activates trailer 14 brakes, upon disconnecting while the towing vehicle 12 and fifth wheel trailer 14 are in motion. Regardless of hitch 16 type, when the towing connection between the trailer 14 and the towing vehicle 12 fails and the system 10 resorts to one or more of the restraining or safety devices 17, and in the case of gooseneck or fifth wheel trailers 14, the bed of the towing vehicle 12 defines the restraining or safety devices 17. In such towing connection failure situations, by resorting to the restraining or safety devices 17, longitudinal flexibility is introduced, whereby the trailer 14 may move longitudinally towards and/or away from the towing vehicle 12. Accordingly, the system 10, and the HFC application 44 monitors the status of the hitch 16 for potential failures.

The systematic management of the towing vehicle 12 dynamics utilizes advanced driver assistance system (ADAS) sensors 18 equipped to, attached to, or otherwise already resident on the towing vehicle 12 to mitigate, reduce from a first level to a second level lower than the first level, and/or entirely avoid any trailer 14 to towing vehicle 12 and/or towed vehicle 12′ to towing vehicle 12 collisions via a hitch 16 failure control (HFC) application 44 stored in memory 36 of the controller 32. More specifically, the HFC application 44 monitors the hitch 16 through collection of optical, SONAR, LiDAR, RADAR, and/or ultrasonic information collected by one or more EM sensors 18A of the towing vehicle 12 and/or towed vehicle 12′ and/or trailer 14. The information from the EM sensors 18A should be understood to include information relating to the position of the hitch 16 relative to the towing vehicle 12, the trailer 14 and/or the towed vehicle 12′.

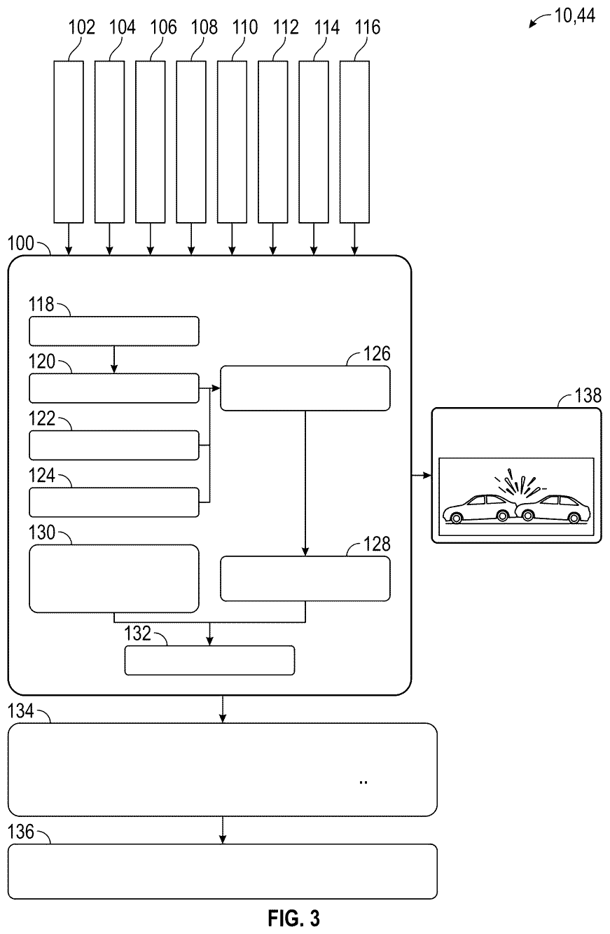

Turning now to FIG. 3 and with continuing reference to FIGS. 1 and 2A-2B, the HFC application 44 is depicted in further detail in the form of a simplified flowchart. The HFC application 44 begins at block 100, in a flexible connection detection subroutine. The flexible connection subroutine takes input from a variety of onboard towing vehicle 12 and/or towed vehicle 12′ and/or trailer 14 sensors 18, processes the inputs from the sensors 18, and determines whether a flexible connection is present. More specifically, the flexible connection detection subroutine utilizes axle torque requests 102 from the towing vehicle 12 operator, wheel speed sensor (WSS) 18D information 104, rear view camera information 106, USS information 108, position and/or dynamic information from one or more IMUs 110, steering angle information from a steering angle sensor (SAS) 112, electronic power steering (EPS) sensor information 114, and trailer 14 brake information 116 (when so-equipped).

The sensor 18 information collected at block 100 is then used to generate a mass estimation at block 118. The mass estimation 118 may be performed in a variety of different manners. In one non-limiting example, the mass estimation 118 is generated through a longitudinal detection algorithm that determines whether the trailer 14 is accelerating or braking at substantially the same rate as the towing vehicle 12. The acceleration determination may be represented mathematically as:

$${\hat{m}}_{a} = \frac{{F}_{a x l}}{{a}_{x}} , \qquad Eq . 1$$

and the braking determination may be represented mathematically as:

$${\hat{m}}_{b} = \frac{{F}_{a x l}}{{a}_{x}} , \qquad Eq . 2$$

where aₓ is a longitudinal acceleration measured by the IMUs 110 such that a mass estimation 102 difference may be represented mathematically as:

$$Δ \hat{m} = \vert {\hat{m}}_{a} - {\hat{m}}_{b} \vert , \qquad Eq . 3$$

where:

$$Δ \hat{m} > Δ {m}^{tr} . \qquad Eq . 4$$

That is, when a change in mass estimation (Δ\hat{m}) indicates that a difference between the estimated vehicle mass when the vehicle is accelerating mass \hat{m}ₐ and the estimated vehicle mass when the vehicle is braking mass \hat{m}_{b} is greater than a mass difference threshold Δm^{tr}, then it is likely that there is a flexible connection between the trailer 14 and the towing vehicle 12.

When the mass estimation at block 118 indicates that a flexible connection is likely to be present, the flexible connection portion of the HFC application 44 proceeds to blocks 120, 122, and 124, where articulated dynamics 120, towing vehicle 12 dynamics 122 and flexible towing 124 dynamics are calculated. It should be noted that while blocks 120, 122, and 124 are depicted as operating substantially in parallel, these processes may occur simultaneously, in parallel, sequentially, in the order represented, or in alternate orders of operation without departing from the scope or intent of the present disclosure.

At block 120, articulated dynamics of the towing vehicle 12/towed vehicle 12′ or towing vehicle 12/trailer 14 system are modeled using data from the sensors 18, and known physical models. Likewise, at block 122, towing vehicle 12 dynamics are modeled using sensor 18 data and physical models of the towing vehicle 12 situationally appropriate for the circumstances under which the towing vehicle 12 is currently operating. Situational appropriateness of the physical models of the towing vehicle 12 may include information relating to a current environment of the towing vehicle 12, road surface grip conditions, towing vehicle 12 speed, towing vehicle 12 load, weight, acceleration, and the like. At block 124, the system 10 and HFC application 44 utilize a flexible towing model to estimate towing vehicle 12 and trailer 14 dynamics, situationally appropriate for the current circumstances, and applicable to a flexible connection between the towing vehicle 12 and the towed vehicle 12′ or trailer 14. Outputs from each of blocks 120, 122, and 124 are forwarded to a multi-modal state estimation 126 portion of the HFC application 44. The multi-modal state estimation 126 combines and processes the data from blocks 120, 122, and 124 through a state machine to generate a model-based estimated state 128, or states of the towing vehicle 12, the towed vehicle 12′ or trailer 14, and combinations thereof. At block 130, the system 10 and HFC application 44 measure states and model independent states of the towing vehicle 12 and the towed vehicle 12′ or trailer 14. Outputs from blocks 128 and 130 are combined at block 132, where a towing type is detected. The towing type defines a mechanism of connection or manner in which the towing vehicle 12 is connected in a towing relationship with the towed vehicle 12′ or trailer 14. In several non-limiting examples, the towing type may include any of the aforementioned hitch 16 types, including: receiver hitches 16 with ball attachments, receiver hitches, 5^{th} wheel hitches, gooseneck hitches, weight distribution hitches, pintle hitches, or the like. Additional towing types may include flexible connections, such as chains, ropes, cables, or any other mechanisms by which the towing vehicle 12 may be attached to the trailer 14 in a towing relationship. Upon determining at block 116 that a flexible towing connection is present, the HFC application 44 proceeds to block 134 where a flexible connection control algorithm is initialized.

The flexible connection control algorithm at block 134 utilizes onboard towing vehicle 12 sensors 18 to detect a gap distance xx, which is the distance between the towing vehicle 12 and the trailer 14 or towed vehicle 12′, and manage the gap distance xᵣ with actuators of at least the powertrain system 22 and braking system 50. The flexible connection control algorithm may be represented mathematically as:

$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$

where: ΔFᵣ is a required corrective longitudinal force, kₚ is a control turning parameter, β₁ is a damping of the vehicle model, e is an error between desired and actual distances between the trailer 14 and the towing vehicle 12, m₁ is a towing vehicle 12 mass, m₂ is a trailer 14 mass, Δxᵣ is a trailer 14 to towing vehicle 12 connection deflection, β₂ is a damping of the trailer 14 model, k is a stiffness of the connection between the trailer 14 and the towing vehicle 12, Fᵣ is a total axle force, v₁ is a longitudinal velocity of the towing vehicle 12, v₂ is a longitudinal velocity of the trailer 14, x_{r,d} is the rope or chain length defining the gap distance, and the towing vehicle 12 and towed vehicle 12′ system or towing vehicle 12 and trailer 14 system may be modeled as:

$$\begin{matrix}{F}_{r} - {β}_{1} {v}_{1} - k Δ {x}_{r} = m {\dot{v}}_{1} & Eq . 6 \\ k Δ {x}_{r} - {β}_{2} {v}_{2} = {m}_{2} {\dot{v}}_{2} & Eq . 7 \\ {v}_{1} - {v}_{2} = {\dot{x}}_{r} ; {\dot{v}}_{1} - {\dot{v}}_{2} = {\ddot{x}}_{r} & Eq . 8\end{matrix}$$

and in a mechanical system using a rope/chain model: If Δxᵣ<0→k=0; and If Δxᵣ>0→k→∞, where x₁>x₂, and e=xᵣ−x_{r,d}. Using the Lyupanov's candidate V:

$$V = \frac{1}{2} {e}^{2} , \qquad Eq . 9$$

and designing Fᵣ as below assures that the flexible connection control algorithm shown above remains as:

$${F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} so long as \dot{V} < 0. \qquad Eq . 5$$

Outputs from the flexible connection control algorithm at block 134 are sent, via the I/O ports 38 to actuators of at least the powertrain system 22 and/or braking system 50, whereupon at block 136 the system 10 manages dynamic performance of the towing vehicle 12 to substantially reduce, prevent, or entirely eliminate collisions between the towing vehicle 12 and the towed vehicle 12′ or trailer 14. In some examples, the system 10 may engage automatic cruise control (ACC) to alter towing vehicle 12 operator actuator commands to smooth or otherwise adapt an acceleration rate or deceleration rate of the towing vehicle 12 to substantially reduce, prevent, or entirely eliminate collisions between the towing vehicle 12 and the towed vehicle 12′ or trailer 14. In additional non-limiting examples, upon detecting at block 132 of a flexible connection towing type, the system 10 and HFC application 44 proceed to block 138 where a rear collision alert is engaged. The rear collision alert may be an audiovisual, haptic, tactile, or other such feedback to the towing vehicle 12 operator that indicates to the operator that there is a longitudinally flexible connection between the towing vehicle 12 and the towed vehicle 12′ or trailer 14, and that such a connection creates a risk of collision. The rear collision alert at block 138 may be generated to the operator continuously, periodically, or only upon detection of the flexible connection. In additional non-limiting examples, the rear collision alert at block 138 may persist until the towing vehicle 12 is brought to a halt, until the system 10 detects that the flexible connection has been eliminated, or upon manual intervention by the towing vehicle 12 operator, including but not limited to: disengaging the rear collision alert through a human machine interface (HMI) of the towing vehicle 12, replacing the flexible connection with a rigid connection, or the like. The rear collision alert at block 138 may be generated by preexisting hardware and/or programmatic control logic resident on the towing vehicle 12, such as a rear collision alert system, a rear virtual bumper, or the like.

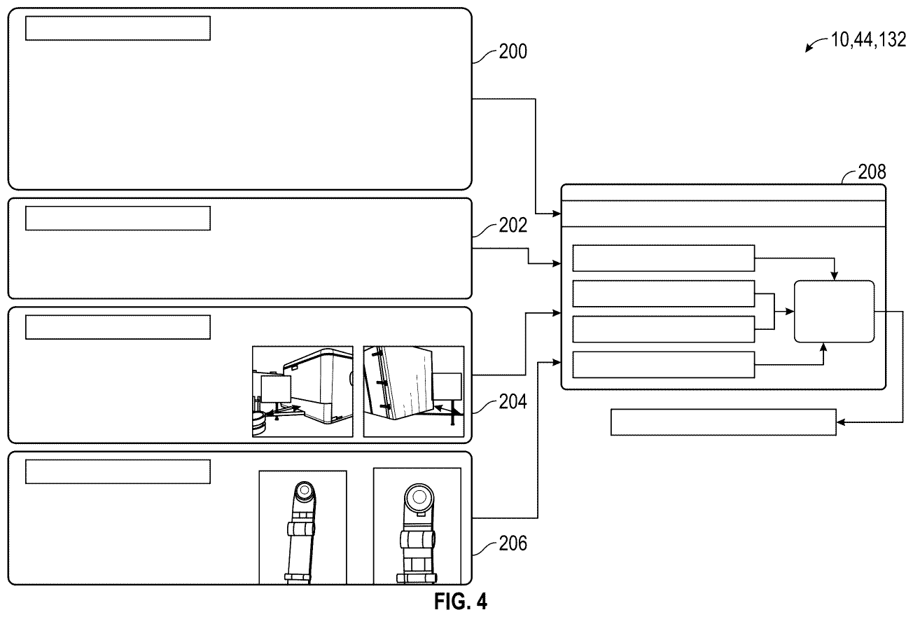

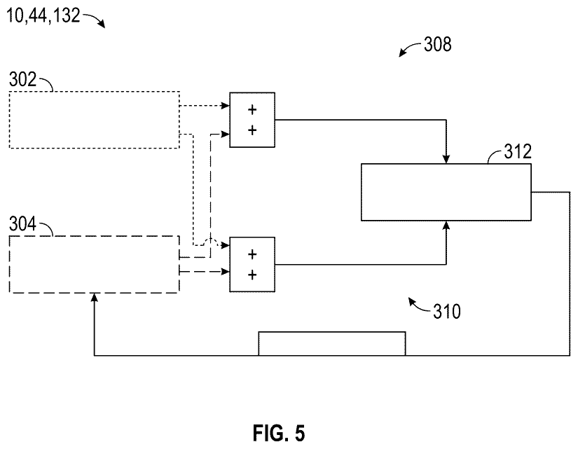

Referring now to FIGS. 4 and 5 and with continuing reference to FIGS. 1-3, the towing type detection subroutine at block 132 of FIG. 3 in the HFC application 44 is shown in additional detail in flowchart form. As described hereinabove, the system 10 and HFC application 44 perform longitudinal detection at block 200 to generate a mass estimation difference Δ\hat{m}=|\hat{m}ₐ−\hat{m}_{b}|. The mass estimation difference is combined with lateral detection information, rear virtual bumper (RVB) detection, and rear visual camera (RVC) detection to ascertain a particular towing type as referenced at block 116 of FIG. 3. Lateral detection at block 202 utilizes understeer and/or oversteer rates of the trailer 14 relative to the towing vehicle 12 to assist in determining whether a flexible connection is present. More specifically, the system 10 and HFC application 44 may determine a change in understeer coefficient, Δkᵤₛ, where:

$$Δ {k}_{us} = \vert Δ {k}_{us} ( k ) - Δ {k}_{us} ( k - 1 ) \vert , \qquad Eq . 10$$

and when a change in understeer coefficient Δkᵤₛ of the towing vehicle 12 exceeds an understeer coefficient difference threshold

$$Δ {k}_{us}^{tr} ,$$

represented as:

$$Δ {k}_{us} > Δ {k}_{us}^{tr} , \qquad Eq . 11$$

then the system 10 and HFC application 44 may determine that a flexible connection between the towing vehicle 12 and the trailer 14 is present.

In RVB detection at block 204, the system 10 and HFC application 44 utilize EM sensors 18A of the towing vehicle 12 to generate an estimated distance between the towing vehicle 12 and the trailer 14 or towed vehicle 12′. In a non-limiting example, the EM sensors 18A used to generate the estimated distance include ultrasonic sensors (USS). When an absolute value of a distance between the trailer 14 and the towing vehicle 12 as measured by an ultrasonic sensor or other such EM sensor 18A (Le) and an initial or base distance between the trailer 14 and the towing vehicle 12 as measured by the ultrasonic or other such EM sensor 18A

$$( {L}_{e}^{init} ) ,$$

is greater than a difference between measured distance and initial distance

$$( {L}_{e}^{tr} ) ,$$

i.e.:

$$\vert {L}_{e} - {L}_{e}^{init} \vert > {L}_{e}^{tr} , \qquad Eq . 12$$

then a flexible connection is present.

At block 206, the system 10 and HFC application 44 perform RVC (rear view camera) detection utilizing one or more EM sensors 18A, and specifically rear-view cameras of the towing vehicle 12. In some non-limiting examples, the rear-view cameras of the towing vehicle 12 have fields of view that include or are directly aimed at the hitch 16, and more specifically at a ball portion of a ball-hitch. It will be appreciated that in a properly-connected and joined receiver hitch 16 with a ball connection, the ball portion of the connection is substantially hidden by the ball receiver of the trailer 14. Accordingly, when the hitch 16 is disconnected, the ball portion of the hitch 16 may become visible to rear-view cameras, rather than being hidden by the portion of the hitch 16 affixed to or otherwise formed as a part of the trailer 14 and/or towed vehicle 12′. In such circumstances, a flexible connection between the towing vehicle 12 and the trailer 14 is likely to be present.

Results from blocks 200, 202, 204, and 206 are forwarded to block 208, where the information is fused and the HFC application 44 generates a connection type based on the fused longitudinal detection information, lateral detection information, RVB detection information, and RVC detection information. In some non-limiting examples, the fused information from block 208 is compared against a database of towing type detection information stored in memory 36. The database of towing type detection information may include experimentally determined towing types, modeled towing types, or the like. From block 208, upon determining that a flexible towing connection exists (i.e. a rope connection, a chain connection, a cable connection, or the like), the system 10 and HFC application 44 proceed to block 134 and to block 138 of FIG. 3.

Turning now to FIG. 5 and with continuing reference to FIGS. 1-5, the HFC application 44 is depicted in further detail in the form of a simplified flowchart. The HFC application 44 utilizes a towing vehicle 12 operator input 302 and a gap distance supervisor 304 input to actively and dynamically manage a gap distance xᵣ between the towing vehicle 12 and the trailer 14 and/or between the towing vehicle 12 and a towed vehicle 12′. The towing vehicle 12 operator input 302 includes a longitudinal command 306 includes one or more of a torque command 308 and a brake command 310. The torque command 308 may include a towing vehicle 12 axle torque command, such as a request to alter a torque output of the towing vehicle's 12 powertrain system 22 actuators. In additional non-limiting examples, the longitudinal command 306 may include a towing vehicle 12 operator command to change a longitudinal speed or acceleration of the towing vehicle 12 by actuation of towing vehicle 12 and/or towed vehicle 12′ and/or trailer 14 braking system 50 actuators. Initial towing vehicle 12 operator inputs 302 are sent to a vehicle-trailer plant 312, including the powertrain system 22 and/or braking system 50, whereupon the powertrain system 22 and/or braking system 50 alter a longitudinal speed, velocity, and/or acceleration of the towing vehicle 12, while continuously monitoring the gap distance xᵣ. The gap distance xᵣ information is sent to the gap distance supervisor 304, which continuously, dynamically, and automatically adjusts the speed, velocity and/or acceleration of the towing vehicle 12 by subtly altering the operator inputs 302 to maintain a gap distance xᵣ at a desired gap distance x_{r_des} that lies within certain predefined and/or adjustable margins according to the control adaptation portion of the HFC application 44 as described and shown in FIG. 4 at block 120.

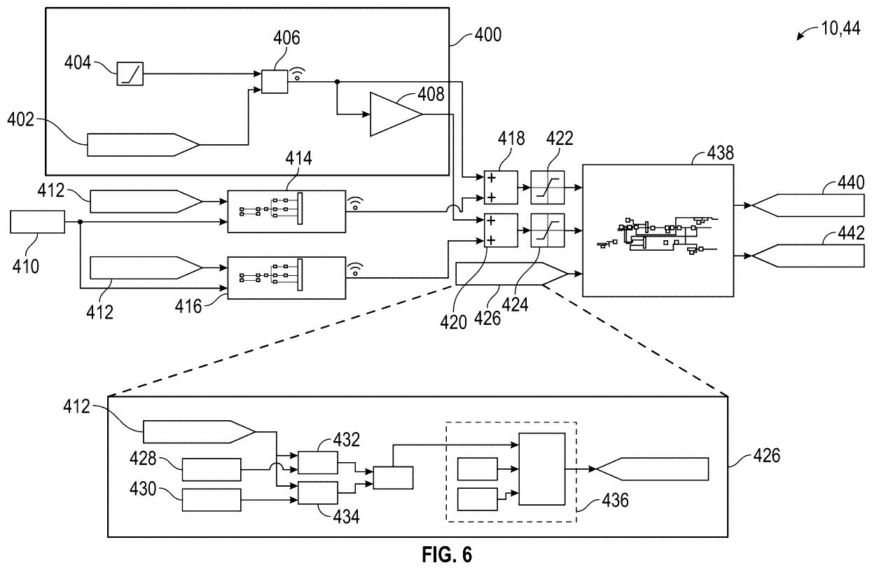

Turning now to FIG. 6 and with continuing reference to FIGS. 1-5, an exemplary flowchart depicting gap distance xᵣ management via the HFC application 44 is shown. In several aspects, towing vehicle 12 operator inputs 302 are defined by a driver brake pressure model 400. The driver brake pressure model 400 utilizes a towing vehicle 12 velocity 402 and a brake friction coefficient 404 as inputs. A ramp up brake pressure slope 406 and the brake friction coefficient 404 are used to determine a trailer 14 braking gain 408. The desired gap distance x_{r_des} at block 410 and current gap distance xᵣ at blocks 412 are used as input to an axle torque controller 414 and a trailer 14 brake controller 416. The axle torque controller 414 generates a target axle torque command F_car_xr that is used as a correction to the driver brake pressure command F_car_v1 at block 418. Similarly, the trailer 14 brake controller 416 generates a target trailer brake command F_trl_xr that is used as a correction to the trailer braking gain 408 at block 420. At block 422 a ramp rate for the target axle torque command F_car_xr corrections to towing vehicle 12 operator brake commands is calculated. Likewise, at block 424 a ramp rate for trailer brake command F_trl_xr corrections to the trailer braking gain 408 is calculated. At block 426, a spring constant k is calculated. The spring constant k is an emulation of the flexibility of the connection between the towing vehicle 12 and towed vehicle 12′ or trailer 14.

The spring constant, k is defined based on several factors, including but not limited to: a current gap distance xr from block 412, and hard constraints or absolute limits defined by the physical characteristics of the flexible connection, and the physical characteristics or dimensions of the trailer 14, towed vehicle 12′ and towing vehicle 12. The hard constraints are defined at blocks 428 as a maximum gap distance xr_max and at block 430, a minimum gap distance of zero. When the minimum gap distance occurs, the towing vehicle 12 and trailer 14 are in physical contact with one another (i.e. a collision has occurred). When the maximum gap distance xr_max occurs, the flexible connection is expanded to a largest possible distance (i.e. a rope or chain connection is stretched as far as possible). In several aspects, the spring constant k is computed to emulate a rope-type hitch 16 with a maximum extended length of xr_max. Based on information from blocks 412 and 428, the HFC application 44 continuously determines, at block 432, whether the maximum gap distance xr_max is greater than or equal to the current gap distance xr. Similarly, at block 434, based on information from blocks 412 and 430, the system 10 and HFC application 44 continuously determines whether the minimum gap distance (i.e. zero) is less than or equal to the current gap distance xr. Based on the comparisons at blocks 432 and 434, the HFC application 44 uses a spring constant calculation algorithm and control logic subroutines to estimate an effective spring constant k of the flexible connection at block 436.

The spring constant k and data from blocks 422 and 424 are used as inputs to a towing vehicle 12-trailer 14 or towing vehicle 12-towed vehicle 12′ plant at block 438, where a supervised gap distance xr at 440 is managed by actively, automatically, and continuously adjusting towing vehicle 12 command inputs to alter or correct the towing vehicle 12 velocity v1 at block 442 to mitigate, reduce, and substantially eliminate bouncing or pogoing of the towing vehicle 12-trailer 14 physical system or towing vehicle 12-towed vehicle 12′ physical system. That is, the system 10 and HFC application 44 operate to adjust control inputs at least to powertrain system 22 actuators and braking system 50 actuators to reduce towing vehicle 12, towed vehicle 12′ and/or trailer 14 wear and tear, parts fatigue, and to keep the gap distance xr away from the maximum gap distance xr_max and zero (0). That is, the system 10 and HFC application 44 continuously, actively, and dynamically manage the gap distance xr to keep the gap distance xr within a predefined range of distance values that effectively prevent collisions between the towing vehicle 12 and trailer 14 or towed vehicle 12′. In some situations, however, collisions between the towing vehicle 12 and trailer 14 may not be entirely avoided because the system 10 and HFC application 44 prioritize towing vehicle 12 operator requests, especially when such requests or commands are of significant magnitude, such as during emergency braking, hard and/or rapid braking, acceleration, or steering inputs for avoidance purposes, or the like. It should further be appreciated that while the system 10 and HFC application 44 of the present disclosure has largely been described herein in forward-driving situations, the system 10 and HFC application 44 may similarly be used in backing situations, on hills, and the like.

It will be appreciated that the system 10 and HFC application 44 of the present disclosure may be applied to control actions of any type of towing vehicle 12 and trailer 14 combinations, including any of a wide variety of different hitch 16 types and attachment systems. In examples in which one or more of the towing vehicle 12, towed vehicle 12′ and/or trailer 14 includes an adaptive suspension system, such as an air-ride suspension, upon detection of a connection failure or a flexible connection, the air-ride or similar suspension system is instructed to perform an immediate ride height reduction (i.e. drop) to increase dynamic stability.

The system 10 and HFC application 44 may further include adaptive control logic that compensates for various physical system uncertainties. In some non-limiting examples, rope or spring constants k may vary based on the types of rope, chains, straps, or cables available and in use. Such spring constant k variability may also be due to conditions, such as rain, snow, or temperature fluctuations. These fluctuations or variations in spring constant k may be adapt to up to ±50% variance in the system 10 and HFC application 44. Similarly, towing vehicle 12 mass and trailer 14 mass may vary substantially based on payload conditions, and under/overestimations of the various masses involved. The system 10 and HFC application 44 may adapt for up to ±20% variability in masses. Road surface conditions can also alter dynamic performances of the towing vehicle 12, towed vehicle 12′ and/or trailer 14 based on the presence or absence of pavement, gravel, mud, water, ice, or the like on the road surface. The system 10 and HFC application 44 can adapt to up to ±20% variance in such road surface uncertainty.

A system 10 for trailer 14 hitch 16 connection failure control in abrupt dynamic disturbances and HFC application 44 of the present disclosure offers several advantages. These include actively, accurately, and automatically reducing, or eliminating the potential for the trailer 14 to collide with the towing vehicle 12 during a hitch 16 connection failure, or under other circumstances where the towing vehicle 12 to trailer 14 or towing vehicle 12 to towed vehicle 12′ connection is flexible, using existing hardware, and maintaining or reduce system 10 complexity, maintain or reduce manufacturing complexity, and which may be retrofitted to existing vehicles that are equipped with appropriate hardware, may be remotely updatable, and while offering improved functionality and redundancy.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for trailer hitch connection failure control in abrupt dynamic disturbances, the system comprising:
a towing vehicle connected to a trailer via a hitch and one or more restraining devices;
one or more sensors integrated into the towing vehicle, the one or more sensors detecting static and dynamic state information about the towing vehicle;
one or more actuators integrated into the towing vehicle, the one or more actuators altering the static and dynamic state of the towing vehicle;
a controller having a processor, a memory, and input/output (I/O) ports, the I/O ports in communication with the one or more sensors and the one or more actuators, the processor executing program code portions stored in the memory, the program code portions including a hitch failure control (HFC) application comprising:
a first control logic for monitoring vehicle static and dynamic state information;
a second control logic for determining that a flexible connection exists between the towing vehicle and the trailer;
a third control logic for performing flexible connection control, including:
a fourth control logic for receiving commands from a towing vehicle operator; and
a fifth control logic for actively, automatically, and dynamically modifying the commands from the towing vehicle operator to maintain relative positions of the towing vehicle and the trailer within a gap distance xᵣ that effectively prevents collisions between the towing vehicle and the trailer.

2. The system of claim 1, wherein the one or more sensors further comprise:
one or more electromagnetic (EM) sensors capturing electromagnetic information about the towing vehicle and the trailer, wherein the electromagnetic information includes optical information capturing the hitch;
one or more inertial measurement units (IMUs) capturing acceleration, velocity, and position information about the towing vehicle and the trailer;
one or more powertrain system sensors, comprising: transmission sensors, and engine control sensors, the powertrain system sensors detecting a state of the powertrain system of the towing vehicle; and
one or more brake sensors, the brake sensors detecting a quantity of torque currently being supplied to one or more axles of the towing vehicle.

3. The system of claim 2, wherein the second control logic further comprises:
control logic for estimating an accelerating mass and a braking mass according to:
$${\hat{m}}_{a} = \frac{{F}_{axl}}{{a}_{x}} ; \qquad Eq . 1$$
$${\hat{m}}_{b} = \frac{{F}_{axl}}{{a}_{x}} , \qquad Eq . 2$$
where \hat{m}ₐ is an accelerating mass of the towing vehicle, and \hat{m}_{b} is a decelerating mass of the towing vehicle, aₓ is a longitudinal acceleration measured by the one or more IMUs, and Fₐₓₗ is a measured force acting on one or more axles of the towing vehicle.

4. The system of claim 3, wherein the second control logic further comprises:
control logic for generating a mass difference estimation according to:
$$Δ \hat{m} = \vert {\hat{m}}_{a} - {\hat{m}}_{b} \vert , \qquad Eq . 3$$
where:
$$Δ \hat{m} > Δ {m}^{tr} . \qquad Eq . 4$$
such that when a change in mass estimation (Δ\vec{m}) is greater than a mass difference threshold Δm^{tr}, then a flexible connection between the trailer the towing vehicle exists.

5. The system of claim 3, wherein the second control logic further comprises:
control logic for performing lateral flexible connection detection based on an understeer coefficient of the towing vehicle Δkᵤₛ and an understeer coefficient threshold
$$Δ {k}_{us}^{tr} ,$$
where:
$$Δ {k}_{us} = \vert Δ {k}_{us} ( k ) - Δ {k}_{us} ( k - 1 ) \vert , \qquad Eq . 10$$
such that a change in understeer coefficient Δkᵤₛ of the towing vehicle that exceeds the understeer coefficient threshold
$$Δ {k}_{us}^{tr} ,$$
represented as:
$$Δ {k}_{us} > Δ {k}_{us}^{tr} , \qquad Eq . 11$$
indicates that a flexible connection between the towing vehicle and the trailer exists.

6. The system of claim 3, wherein the second control logic further comprises:
control logic for measuring and generating, via the EM sensors, an estimated distance between the towing vehicle and the trailer, and upon determining that the estimated distance exceeds a predetermined hitched distance at rest changes while the towing vehicle and trailer are in motion, a longitudinally flexible connection is detected; and
control logic for performing ball joint detection with information from the one or more EM sensors, and upon detecting a ball joint, determining that a flexible connection is present.

7. The system of claim 2, wherein the third control logic further comprises:
control logic for utilizing a driver brake pressure model to generate a trailer braking gain and a towing vehicle velocity;
control logic for monitoring, via a towing vehicle axle torque controller, a current gap distance and comparing the current gap distance to a desired gap distance, and generating a towing vehicle axle torque command;
control logic for monitoring, via a trailer brake controller, the current gap distance and comparing the current gap distance to the desired gap distance, and generating a trailer brake command; and
control logic for combining the towing vehicle velocity and the towing vehicle axle torque command, and control logic for combining the trailer brake command and the trailer braking gain.

8. The system of claim 7, wherein the third control logic further comprises:
control logic for calculating a spring constant that emulates a rope-type hitch with a maximum length of xr_max and a minimum length of zero, wherein the minimum length of zero indicates the towing vehicle and the trailer are in contact with one another, and wherein the maximum length xr_max defines a condition in which the flexible connection, defined by the one or more restraining devices, is expanded to a largest possible distance.

9. The system of claim 8, wherein the fourth control logic further comprises:
control logic for calculating a supervised gap distance and a corrected velocity of the towing vehicle (v1) that mitigates, reduces, or substantially eliminates bouncing or pogoing of a towing vehicle-trailer physical system.

10. The system of claim 9, wherein the fifth control logic further comprises:
control logic that executes a flexible connection control algorithm that actively, automatically, and continuously adjusts towing vehicle operator command inputs to alter or correct the towing vehicle velocity v1 according to:
$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$
where: ΔFᵣ is a required corrective longitudinal force, kₚ is a control turning parameter, β₁ is a damping of the vehicle model, e is an error between desired and actual distances between the trailer and the towing vehicle, m₁ is a towing vehicle mass, m₂ is a trailer mass, Δxᵣ is a trailer to towing vehicle connection deflection, β₂ is a damping of the trailer model, k is a stiffness of the connection between the trailer and the towing vehicle, Fᵣ is a total axle force, v₁ is a longitudinal velocity of the towing vehicle, v₂ is a longitudinal velocity of the trailer, x_{r,d} is a length of the restraining device defining the gap distance xᵣ; and
wherein outputs of the flexible connection control algorithm are used as inputs to one or more advanced driver assistance system (ADAS) functions of the towing vehicle that dynamically, automatically, and continuously alter a longitudinal acceleration or deceleration of the towing vehicle to mitigate, reduce, or substantially eliminate collisions between the towing vehicle and the trailer while a flexible connection between the towing vehicle and the trailer is present.

11. A method for trailer hitch connection failure control in abrupt dynamic disturbances, the method comprising:
detecting, via one or more sensors integrated into a towing vehicle, static and dynamic state information about the towing vehicle, the towing vehicle connected to a trailer via a hitch and one or more restraining devices;
altering, via one or more actuators integrated into the towing vehicle, the static and dynamic state of the towing vehicle;
executing, with a processor of a controller, program code portion stored in memory of the controller, the controller further having one or more input/output (I/O) ports in communication with the one or more sensors and the one or more actuators, the program code portions including a hitch failure control (HFC) application comprising control logic for:
monitoring vehicle static and dynamic state information;
determining that a flexible connection exists between the towing vehicle and the trailer;
performing flexible connection control, including:
receiving commands from a towing vehicle operator; and
actively, automatically, and dynamically modifying the commands from the towing vehicle operator to maintain relative positions of the towing vehicle and the trailer within a gap distance xr that effectively prevents collisions between the towing vehicle and the trailer.

12. The method of claim 11, further comprising:
capturing, via one or more electromagnetic (EM) sensors, electromagnetic information about the towing vehicle and the trailer, wherein the electromagnetic information includes optical information relating to the hitch;
capturing, via one or more inertial measurement units (IMUs), acceleration, velocity, and position information about the towing vehicle and the trailer;
detecting, via one or more powertrain system sensors, a state of a powertrain system of the towing vehicle, the powertrain system sensors comprising: transmission sensors, and engine control sensors; and
detecting, via one or more brake sensors, a quantity of torque currently being supplied to one or more axles of the towing vehicle.

13. The method of claim 12, further comprising:
estimating an accelerating mass and a braking mass according to:
$${\hat{m}}_{a} = \frac{{F}_{axl}}{{a}_{x}} ; \qquad Eq . 1$$
$$and$$
$${\hat{m}}_{b} = \frac{{F}_{axl}}{{a}_{x}} , \qquad Eq . 2$$
where \hat{m}ₐ is an accelerating mass, and \hat{m}_{b} is a decelerating mass, Fₐₓₗ is a measured force acting on one or more axles of the towing vehicle, and aₓ is an acceleration of the towing vehicle in an x direction.

14. The method of claim 13, further comprising:
generating a mass difference estimation according to:
$$Δ \hat{m} = \vert {\hat{m}}_{a} - {\hat{m}}_{b} \vert , \qquad Eq . 3$$
where:
$$Δ \hat{m} > Δ {m}^{tr} . \qquad Eq . 4$$
such that when a change in mass estimation (Δ\hat{m}) is greater than a mass difference threshold Δm^{tr}, then a flexible connection between the trailer the towing vehicle exists.

15. The method of claim 13, further comprising:
performing lateral flexible connection detection based on an understeer coefficient of the towing vehicle Δkᵤₛ and an understeer coefficient threshold
$$Δ {k}_{us}^{tr} ,$$
where:
$$Δ {k}_{u s} = \vert Δ {k}_{u s} ( k ) - Δ {k}_{u s} ( k - 1 ) \vert , \qquad Eq . 10$$
such that a change in understeer coefficient Δkᵤₛ of the towing vehicle that exceeds the understeer coefficient threshold
$$Δ {k}_{us}^{tr} ,$$
represented as:
$$Δ {k}_{u s} > Δ {k}_{u s}^{tr} , \qquad Eq . 11$$
indicates that a flexible connection between the towing vehicle and the trailer exists.

16. The method of claim 13, further comprising:
measuring and generating, via the EM sensors, an estimated distance between the towing vehicle and the trailer, and upon determining that the estimated distance exceeds a predetermined hitched distance at rest changes while the towing vehicle and trailer are in motion, a longitudinally flexible connection is detected; and
performing ball joint detection with information from the one or more EM sensors, and upon detecting a ball joint, determining that a flexible connection is present.

17. The method of claim 12, further comprising:
generating, with a driver brake pressure model, a trailer braking gain and a towing vehicle velocity;
monitoring, via a towing vehicle axle torque controller, a current gap distance and comparing the current gap distance to a desired gap distance, and generating a towing vehicle axle torque command;
monitoring, via a trailer brake controller, the current gap distance and comparing the current gap distance to the desired gap distance, and generating a trailer brake command; and
combining the towing vehicle velocity and the towing vehicle axle torque command, and control logic for combining the trailer brake command and the trailer braking gain.

18. The method of claim 17, further comprising:
calculating a spring constant that emulates a rope-type hitch with a maximum length of xr_max and a minimum length of zero, wherein the minimum length of zero indicates the towing vehicle and the trailer are in contact with one another, and wherein the maximum length xr_max defines a condition in which the flexible connection, defined by the one or more restraining devices, is expanded to a largest possible distance; and
calculating a supervised gap distance and a corrected velocity of the towing vehicle (v1) that mitigates, reduces, or substantially eliminates bouncing or pogoing of a towing vehicle-trailer physical system.

19. The method of claim 18, further comprising:
executing a flexible connection control algorithm that actively, automatically, and continuously adjusts towing vehicle operator command inputs to alter or correct the towing vehicle velocity v1 according to:
$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$
where: ΔFᵣ is a required corrective longitudinal force, kₚ is a control turning parameter, β₁ is a damping of the vehicle model, e is an error between desired and actual distances between the trailer and the towing vehicle, m₁ is a towing vehicle mass, m₂ is a trailer mass, Δxᵣ is a trailer to towing vehicle connection deflection, β₂ is a damping of the trailer model, k is a stiffness of the connection between the trailer and the towing vehicle, Fᵣ is a total axle force, v₁ is a longitudinal velocity of the towing vehicle, v₂ is a longitudinal velocity of the trailer, x_{r,d} is a length of the restraining device defining the gap distance xᵣ; and
wherein outputs of the flexible connection control algorithm are used as inputs to one or more advanced driver assistance system (ADAS) functions of the towing vehicle that dynamically, automatically, and continuously alter a longitudinal acceleration or deceleration of the towing vehicle to mitigate, reduce, or substantially eliminate collisions between the towing vehicle and the trailer while a flexible connection between the towing vehicle and the trailer is present.

20. A method for trailer hitch connection failure control in abrupt dynamic disturbances, the method comprising:
detecting, via one or more sensors integrated into a towing vehicle, static and dynamic state information about the towing vehicle, the towing vehicle connected to a trailer via a hitch and one or more restraining devices;
altering, via one or more actuators integrated into the towing vehicle, the static and dynamic state of the towing vehicle;
executing, with a processor of a controller, program code portion stored in memory of the controller, the controller further having one or more input/output (I/O) ports in communication with the one or more sensors and the one or more actuators, the program code portions including a hitch failure control (HFC) application comprising control logic for:
monitoring vehicle static and dynamic state information, including:
capturing, via one or more electromagnetic (EM) sensors, electromagnetic information about the towing vehicle and the trailer, wherein the electromagnetic information includes optical information relating to the hitch;
capturing, via one or more inertial measurement units (IMUs), acceleration, velocity, and position information about the towing vehicle and the trailer;
detecting, via one or more powertrain system sensors, a state of a powertrain system of the towing vehicle, the powertrain system sensors comprising: transmission sensors, and engine control sensors; and
detecting, via one or more brake sensors, a quantity of torque currently being supplied to one or more axles of the towing vehicle;
determining that a flexible connection exists between the towing vehicle and the trailer, including:
estimating an accelerating mass and a braking mass according to:
$${\hat{m}}_{a} = \frac{{F}_{axl}}{{a}_{x}} ; and \qquad Eq . 1$$
$${\hat{m}}_{b} = \frac{{F}_{axl}}{{a}_{x}} , \qquad Eq . 2$$
\hat{m}ₐ is an accelerating mass of the towing vehicle, and \hat{m}_{b} is a decelerating mass of the towing vehicle, aₓ is a longitudinal acceleration measured by the one or more IMUs, and Fₐₓₗ is a measured force acting on one or more axles of the towing vehicle;
generating a mass difference estimation according to:
$$Δ \hat{m} = \vert {\hat{m}}_{a} - {\hat{m}}_{b} \vert , \qquad Eq . 3$$
where:
$$Δ \hat{m} > Δ {m}^{tr} . \qquad Eq . 4$$
such that when a change in mass estimation (Δ\hat{m}) is greater than a mass difference threshold Δm^{tr}, then a flexible connection between the trailer the towing vehicle exists;
performing lateral flexible connection detection based on an understeer coefficient of the towing vehicle Δkᵤₛ and an understeer coefficient threshold
$$Δ {k}_{us}^{tr} ,$$
where:
$$Δ {k}_{u s} = \vert Δ {k}_{u s} ( k ) - Δ {k}_{u s} ( k - 1 ) \vert , \qquad Eq . 10$$
such that a change in understeer coefficient Δkᵤₛ of the towing vehicle that exceeds the understeer coefficient threshold
$$Δ {k}_{us}^{tr} ,$$
represented as:
$$Δ {k}_{u s} > Δ {k}_{u s}^{tr} , \qquad Eq . 11$$
indicates that a flexible connection between the towing vehicle and the trailer exists;
measuring and generating, via the EM sensors, an estimated distance between the towing vehicle and the trailer, and upon determining that the estimated distance exceeds a predetermined hitched distance at rest changes while the towing vehicle and trailer are in motion, a longitudinally flexible connection is detected; and
performing ball joint detection with information from the one or more EM sensors, and upon detecting a ball joint, determining that a flexible connection is present;
performing flexible connection control, including:
receiving commands from a towing vehicle operator, and
generating, with a driver brake pressure model, a trailer braking gain and a towing vehicle velocity;
monitoring, via a towing vehicle axle torque controller, a current gap distance and comparing the current gap distance to a desired gap distance, and generating a towing vehicle axle torque command;
monitoring, via a trailer brake controller, the current gap distance and comparing the current gap distance to the desired gap distance, and generating a trailer brake command; and
combining the towing vehicle velocity and the towing vehicle axle torque command, and control logic for combining the trailer brake command and the trailer braking gain;
calculating a spring constant that emulates a rope-type hitch with a maximum length of xr_max and a minimum length of zero, wherein the minimum length of zero indicates the towing vehicle and the trailer are in contact with one another, and wherein the maximum length xr_max defines a condition in which the flexible connection, defined by the one or more restraining devices, is expanded to a largest possible distance;
calculating a supervised gap distance and a corrected velocity of the towing vehicle (v1) that mitigates, reduces, or substantially eliminates bouncing or pogoing of a towing vehicle-trailer physical system;
executing a flexible connection control algorithm that actively, automatically, and continuously adjusts towing vehicle operator command inputs to alter or correct the towing vehicle velocity v1 according to:
$$Δ {F}_{r} = - {k}_{p} {β}_{1} e + {β}_{1} {v}_{2} + \frac{{m}_{1} ( k Δ {x}_{r} - {β}_{2} {v}_{2} )}{{m}_{2}} + {m}_{1} {\ddot{x}}_{r} + k Δ {x}_{r} , \qquad Eq . 5$$
where: ΔFᵣ is a required corrective longitudinal force, kₚ is a control turning parameter, β₁ is a damping of the vehicle model, e is an error between desired and actual distances between the trailer and the towing vehicle, m₁ is a towing vehicle mass, m₂ is a trailer mass, Δxᵣ is a trailer to towing vehicle connection deflection, β₂ is a damping of the trailer model, k is a stiffness of the connection between the trailer and the towing vehicle, Fᵣ is a total axle force, v₁ is a longitudinal velocity of the towing vehicle, v₂ is a longitudinal velocity of the trailer, x_{r,d} is a length of the restraining device that defines the gap distance xᵣ; and
wherein outputs of the flexible connection control algorithm are used as inputs to one or more advanced driver assistance system (ADAS) functions of the towing vehicle that actively, dynamically, automatically, and continuously alter or modify the commands from the towing vehicle operator to adjust a longitudinal acceleration or deceleration of the towing vehicle and to maintain relative positions of the towing vehicle and the trailer within the gap distance xx that effectively prevents collisions between the towing vehicle and the trailer while a flexible connection between the towing vehicle and the trailer is present.
